(19) United States
(12) Patent Application Publication
(10) Pub. No.: US 2002/0157308 A1
(43) Pub. Date: Oct. 31, 2002

(54) Display case

(76) Inventor: John A. Hanis, Grand Haven, MI (US)

Correspondence Address: Craig A. Phillips, 900 Fifth Third Center, 111 Lyon Street, N.W., Grand Rapids, MI, 49503-2487, US

(21) Appl. No.: 10/122,603

(22) Filed: Apr. 15, 2002

Related U.S. Application Data
(60) Provisional application No. 60/286,836, filed on Apr. 26, 2001.

(51) Int. Cl. A01G 5/00

(52) U.S. Cl. 47/41.01

(57) ABSTRACT

A display case that provides fresh water and a refrigerated environment for cut flowers while aesthetically displaying the flowers. The display case includes a watering system that provides fresh water to a plurality of troughs in a terraced relationship. The troughs included removable covers to provide easy and visible access for cleaning the troughs. Timers may be included to allow the display case to automatically freshen the water within the troughs.

### PRIORITY CLAIM

This application claims priority from Provisional Application No. 60/286,836 filed Apr. 26, 2001, entitled “Display Case”.

### BACKGROUND OF THE INVENTION

1. Field of Invention

The present invention relates to display cases and more particularly, to display cases for cut flowers or live plants.

2. Description of the Art

The demand for fresh cut flowers has been increasing, especially for flowers sold by the stem for arrangement by the consumer. Fresh cut flowers may also be sold as prearranged bouquets or a bunch of the same type of flower. Cut flowers are highly perishable and maintain a fresh appearance for a limited time. Cut flowers must maintain a fresh appearance both in the store, and for some time after the sale, not only to entice consumers to buy flowers while in the store, but also to entice them to buy fresh flowers in the future. Cut flowers that lose their fresh appearance in the store must be discarded at a high cost to retailers.

Cut flowers offered for sale in retail stores are generally stored and displayed in buckets or other containers of liquid. To maintain their fresh appearance and prolong their useful lifetime, cut flowers are generally kept in refrigerated environments. In most floral stores and some larger retail stores, the flowers are displayed in individual buckets in large walk-in coolers. These walk-in coolers are expensive to purchase, operate and maintain. Walk-in coolers also take a large portion of valuable floor space, especially in retail stores. In most walk-in coolers, the flowers sit in buckets on the floor. These buckets display the flowers in an unaesthetically pleasing manner, and make it difficult for consumers to select flowers for arrangement into a bouquet. To aesthetically display flowers, expensive display racks or cases must be placed in these walk-in coolers. These display racks usually are specially made to fit inside the walk-in cooler.

Even if cut flowers are kept in a refrigerated environment, bacteria or other microorganisms may accumulate or grow in the water that provides nutrients to the flowers. These bacteria or microorganisms may decrease the useful lifetime of cut flowers. To prevent the cut flowers from losing their fresh appearance due to bacteria or microorganism growth, the water must regularly be changed. Water changes are also a necessity to keep the flowers supplied with nutrients that help maintain a fresh appearance. Individually changing the water in each bucket is time consuming and may damage fragile flowers as they or the buckets are handled during a water change.

To address these problems, some manufacturers have provided refrigerated display cases in which these buckets sit upright, but this provides an unaesthetically pleasing display. Other manufacturers have provided display cases containing individual buckets on racks. Even though some of these display cases address the refrigeration problem, they still present problems in maintaining the fresh appearance of flowers due to water that lacks nutrients, water that is full of bacteria or microorganisms, and through the handling of the flowers during water changes.

Another structure for displaying these flowers can be found in U.S. Pat. No. 4,884,364 to Ferris which discloses a display case having troughs stacked vertically on top of one another and includes a liquid circulation means to preserve the freshness of the flowers. The liquid circulation helps maintain the fresh appearance of the flowers but the open troughs make it difficult to display flowers in an aesthetically pleasing manner. The open troughs also prevent or make it difficult to select flowers to form arrangements, and prevent retailers from displaying individual arrangements of flowers. This display case does not provide refrigeration to maintain the freshness of the flowers. Further, the troughs must be arranged in a vertical manner for the liquid circulation. The vertical arrangement of the troughs can be unaesthetically pleasing and make individual flowers difficult to select and remove without bumping or crushing other flowers. Open vertical troughs also make it difficult for a consumer to visualize a separate bouquet of flowers. The watering system may also become easily clogged with debris because the flowers sit in open troughs through which petals and other debris may easily enter the trough and flow into the drains on the troughs.

Another display case for bouquets of cut flowers is disclosed in U.S. Pat. No. 4,953,363 to Primozic. This display case provides a refrigerated environment with a plurality of tubular manifolds extending substantially horizontally and parallel to one another in a spaced upwardly terraced relationship from the open front to the back wall of the case. Each manifold includes upwardly facing openings to receive and support stem portions of cut flower bouquets. A water circulation means allows fresh water to circulate to each manifold. As the flowers lose petals and other material, the open floral cups allow large debris to become trapped in the tubular shape clogging drains and causing build up of decomposing biological matter. Any build-up of decomposing biological matter increases the amount of bacteria and microorganisms in the water, thereby decreasing the lifetime of the flowers.

The enclosed tubular manifolds in the Primozic display case are difficult to clean, making it hard to provide a debris and bacteria free environment for the flowers. The enclosed tubes also make if difficult to access clogged drains, solenoid valves and float valves. Further, the enclosed tubular manifolds prevent viewing of the areas being cleaned making it difficult to ensure the tubular manifolds are fully clean. The lack of visibility of the areas being cleaned may also allow fingers or other materials to become caught in the float valves or solenoids during cleaning. The disclosed display case also includes a complicated system for refreshing the circulated water. Multiple switches, float valves, solenoids and other parts are used to provide for water circulation. This increases the cost of the display case, installation time, and complicates the operation of the watering system. Another problem with the display case is that the refrigeration system directs the cooled air directly across the flowers. The cooled air exits through a plurality of holes on the top and between the shelves. The cooled air as it blows directly across the flowers, may cause the flowers to become wilted. The flowers also obstruct or reflect the flow of air, causing cooled air to be lost outside of the display case, thereby lowering the efficiency of the cooling system in the display case and increasing the cost to operate the display case. The use of tubular manifolds also limits the depth of the floral cup that may be used. If the floral cup is too shallow, the flowers may be unstable in the cups. If the floral cups are made deep, they are unaesthetically pleasing because they extend well beyond the top of the manifold, preventing a full display of the flowers.

### SUMMARY OF THE INVENTION

The aforementioned problems are overcome by the present invention comprising a display case that maintains the fresh appearance of cut flowers while aesthetically displaying the flowers.

The display case further includes a floral display system. The floral display system uses troughs in a terraced relationship. The terrace is slightly steep to allow all products in the display case to be within easy reach of the consumer. The steep terrace also allows the display case to have a shallower depth to minimize the amount of floor space required for the display case. The troughs include covers that are removable to allow the user to visibly clean any debris and bacteria buildup from within the troughs. The covers have flower supports that aesthetically display the flowers in bunches. The flower cups are deep enough to properly support the cut flowers and are somewhat recessed into the troughs to provide an aesthetic display of the flowers. This allows for individual cut flowers to be separated into bunches of a specific flower or into individual prearranged bouquets. The flower cups may be integral to the covers, or separate cups supported by the covers.

The watering system provides nutrients and fresh water to the flowers. The watering system is a simple design with few simple parts, easy to service, and simple to clean and maintain. The troughs include mesh screens to prevent flower debris from clogging the drains. The watering system prevents the propagation of microorganisms in the water and provides nutrients to the flowers to maintain a fresh appearance. The watering system may be set to a timer to provide water circulation only when needed, thereby operating more efficiently than a continuous circulation system. The timers and switches are accessible from the front of the display case, allowing for easy operation and control of the display case.

The display case includes a climate-controlled environment to preserve the fresh appearance of cut flowers. The climate controlled display case includes a cooling means that incorporates an air curtain. The air curtain provides a thermocline that separates the air inside the display case from the air outside the display case to more efficiently keep the contents within the display case cool. The air curtain is also situated to prevent the cool air from continually blowing directly on the flowers thereby preventing the flowers from wilting. Because the air curtain passes somewhat in front of the flowers or over the tops of the flowers, the cooled air is circulated back into the cooling system, without being deflected by the flowers, allowing a more efficient operation.

These and other objects, advantages and features of the invention will be more fully understood and appreciated by reference to the detailed description of the preferred embodiments.

### BRIEF DESCRIPTION OF THE DRAWINGS

FIG. 1 is a perspective view of the display case shown without the right side end panel;

FIG. 2 is a perspective view of a floral cup for use with the display case;

FIG. 3 is an end view of the watering system;

FIG. 4 is a top view of a watering trough with broken lines representing a screen;

FIG. 5 is a perspective view of the screen in a trough, the trough being broken to represent an indeterminate length;

FIG. 6 is a schematic view of the watering system;

FIG. 7 is a sectional view of the display case with arrows depicting airflow;

FIG. 8 is an end view of a first alternative display case; and

FIG. 9 is a perspective view of a second alternative display case.

### DETAILED DESCRIPTION OF THE PREFERRED EMBODIMENT

The present invention provides a display case 10 with a refrigerated environment and a water circulation means that aesthetically displays cut flowers and is easy to clean. The display case 10 generally includes an outer case 12, a floral display system 30, a watering means 60 and a cooling system 90.

I. Construction

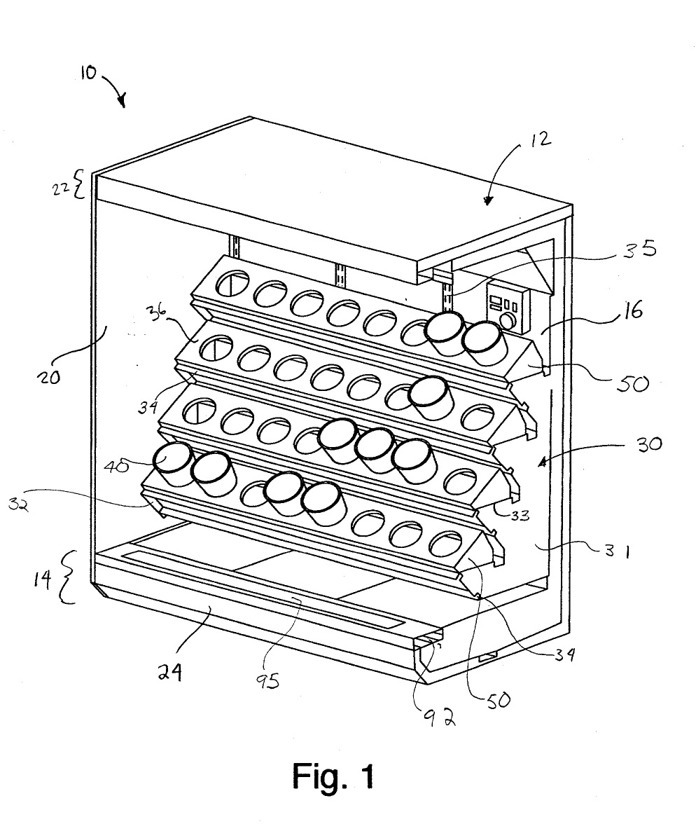

The outer case 12 includes a base 14, a rear wall 16, a right side panel (not shown), a left side panel 20, a top member 22, and a front skirt 24. The outer case 12 can be aesthetically modified to match various decors and styles. The outer case 12 may be manufactured without a right side panel (not shown), a left side panel 20, or both the left and right side panels 18 and 20, to allow the display case 10, as shown in FIG. 1, to be matched with display cases to form a continuous unit. The side panels may include a glass portion, not shown, to improve the aesthetic qualities of the display case 10. The front of the display case 10 is open giving access to the contents. The display case 10 may also include lights and other optional features, as desired to improve the aesthetic display of the flowers.

The floral display system 30 fits inside the display case 10. The floral display system 30 includes a right and left bracket 31 and 32, support rails 34, height rails 35, troughs 50, covers 38, and floral cups 40. The support brackets 31 and 32, support rails 34 and height rails 35 are formed from 11 gauge steel in the preferred embodiment. The left and right brackets 31 and 32 engage the height rails 35 in a means well known in the art for supporting shelving. The left and right brackets 31 and 32 are generally formed from a flat sheet of metal. The brackets 31 and 32 include a plurality of flat level surfaces 33 that form a terraced effect. When the brackets 31 and 32 are installed in a display case, the flat level surfaces 33 recede toward the rear wall 16 as the height of each level 33 increases. A plurality of support rails 34 are supported by the left and right brackets 31 and 32. In the preferred embodiment, the support rails 34 are attached approximately at the sides and slightly below the flat level surfaces 33, as shown in FIG. 1. The support rails 34 run somewhat parallel to the front of the display case 10 and are in a spaced relationship to receive the troughs 50 therebetween.

The troughs 50 rest on the support rails 34, somewhat in the areas of the flat level surfaces 33 on the brackets 31 and 32. In the preferred embodiment, the troughs are formed from 3/16″ ABS plastic. The troughs 50 are sized and shaped to fit between and be supported by the support rails 34. The troughs 50 may be interconnected to the support rails 34, by a lip, ledge, clip, screw rivet or any other such method. In an alternative embodiment, the troughs may include supports that interconnect to the brackets 31 and 32 so that the display case 10 may be manufactured without the support rails 34. The terraced effect of the brackets 31 and 33 causes the troughs 50 to also be in a terraced relationship with each other. This terraced relationship allows the troughs 50 to be vertically and horizontally offset from one another within the display case 10. The troughs 50 fit within the support rails 34 so that the top of the trough 50 is angled toward the front of the display case 10. The troughs 50 are shaped in a modified pentagram configuration. The front side 51 of the troughs 50 is approximately the longest side of the troughs 50 and rests against the supporting rails 34, more specifically the front upper support rail 57 and the front lower support rail 58. The bottom side 52 of the troughs 50 extends upwardly and rearward in a somewhat parallel configuration with the top side 53 of the troughs 50. The troughs 50 further include an upper and lower rear side 54 and 55. The lower rear side 55 of the trough 50 is angled to work in conjunction with the rear support rail 59 to hold the top side 53 of the trough 50 at the proper aesthetic angle to the consumer.

The troughs 50 may include covers 38. In the preferred embodiment, the covers 38 are completely removable from the troughs 50, although in other embodiments they may be hinged or otherwise attached. The covers 38 include a lip 39 that surrounds and positions the covers 38 over the troughs 50. The covers 38 also define a plurality of openings 39 to receive and support the floral cups 40. In the preferred embodiment, the openings 39 are spaced at regular intervals for an aesthetic display, but other arrangements may be used. The covers 38 are also useful in preventing larger debris, such as petals, leaves and stems from entering the troughs 50 and clogging the watering system 60. The covers 38 also prevent flowers from falling into the trough while the floral cups 40 are being filled, or the consumers are picking out flowers. The covers 38 further provide a barrier between the water in the trough and the outside air, reducing the amount of other contaminants, such as bacteria and microorganisms that may enter the water.

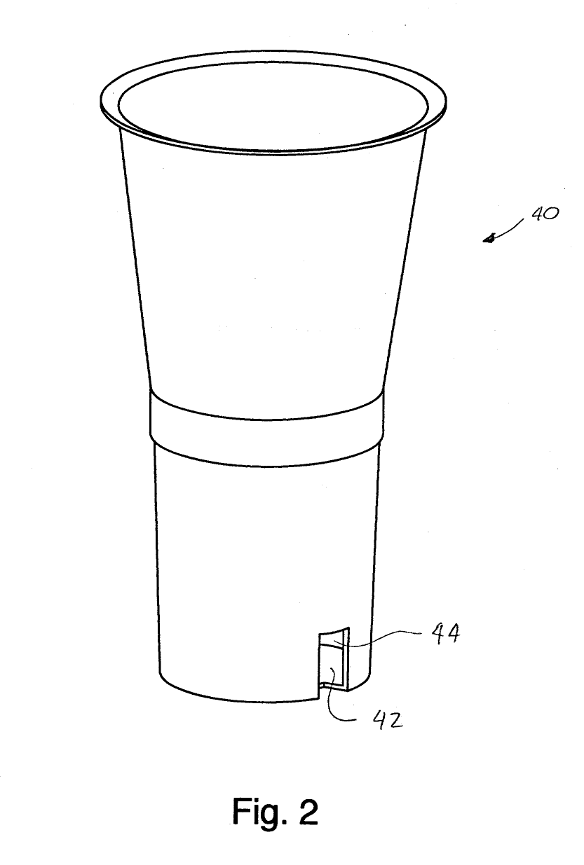

A plurality of floral cups 40 sit within the openings 39 to display the flowers. The floral cups 40 can be made in almost any shape or size, but in the preferred embodiment are somewhat round. The flower cups 40 are also somewhat of an inverted frustro-conical shape, as shown in FIG. 2. The upwardly opening frustro-conical shape allows the flowers to be placed in a more aesthetic arrangement without crushing the flowers. In the preferred embodiment, the floral cups 40 include a flat bottom 42 for the stems of the flowers to rest against. The floral cups 40 also define slots 44 on the sides and bottoms, as shown in FIG. 2, to allow the water to pass through the floral cup 40, thereby providing nutrients to the flowers and washing away any contaminants. The flat bottom 42 and somewhat narrow slots 44 prevent larger debris that is loose within the floral cup from entering the troughs 50, decreasing the number of times the troughs 50 need to be cleaned. The design of the floral cups 40 also reduces the potential for any debris to clog the watering system 60. The floral cup 40 may rest on the covers 38, elevating the bottom 42 of the floral cup 40 slightly above the bottom of the trough 50. An elevated floral cup 40 allows water to pass through the troughs 50 easier. Of course other options of supporting the floral cup 40 may readily be used.

The watering system 60 generally includes a water intake system 62, a drain system 64, and a control box 66. The control box 66 controls the water intake system 62 and the drain system 64, which work in conjunction to provide fresh nutrients to the cut flowers within the floral cups 40 while removing debris, bacteria and microorganisms.

The control box 66 allows the user to control the watering system, the drainage system and the cooling system 90. The control box 66 generally includes a timer 68, power switches 67, and temperature controls 69. In the preferred embodiment, the power switches include a timer switch and a main power switch. The control box may be digital, mechanical, or a combination thereof.

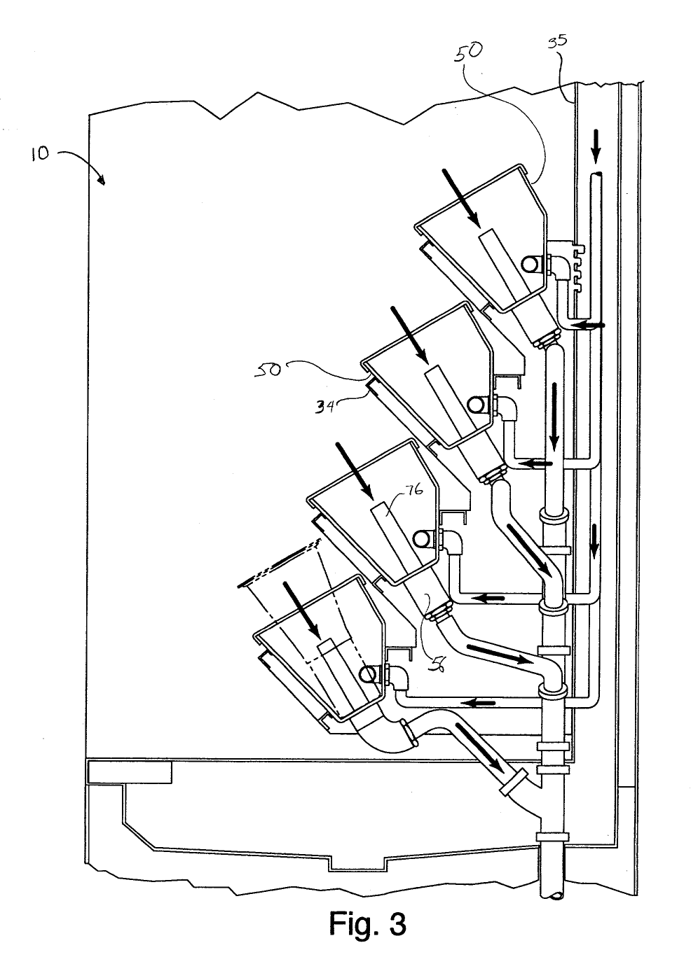

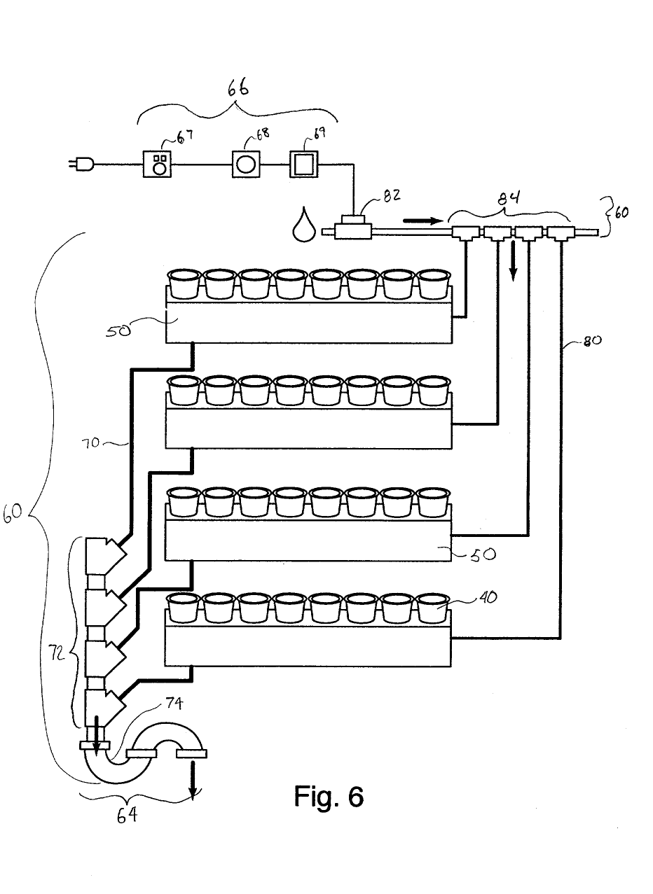

The drain system 64 includes a plurality of individual pipes 70 selected to fit within the display case 10 and direct water from the troughs 50 to the drain manifold 72. In the preferred embodiment, the pipes are constructed from PVC, although other materials may be easily used. The drain manifold 72 is connected to a drain trap 74, as shown in FIG. 6. The drain trap 74 prevents odors from entering the air within or around the display case to maintain a fresh clean smell. The individual pipes 70 are connected to a drain 56 in the bottom 52 of each trough 50. The drain 56 is sized and shaped to receive and support an overflow tube 76. The overflow tube 76 fits within the drain 56, as shown in FIGS. 3-5. The overflow tube 76 preferably fits snugly within the drain 56 to prevent water from seeping around the outside of the overflow tube 76 into the drain 56. This helps maintain proper water level within the troughs 50 and prevents water from being wasted. The overflow tube 76 is sized in height to allow the water to maintain a certain level, yet prevent the trough 50 from being overfilled to the point where the water may spill out of the trough 50 and into the display case 10. The use of only an overflow tube 76 to maintain the proper water level or to empty the troughs 50 for cleaning eliminates complicated pump systems.

The troughs 50 may also include screens 78, as shown in FIG. 5. In the preferred embodiment, the screens 78 define a plurality of holes 79 through which the water passes. The screens 78 block debris from entering the overflow tube 76 and potentially clogging the overflow tube 76 or the drain system 64. The screens 78 are not placed directly on the opening of the overflow tube 76, but somewhat around the overflow tube 76 and spaced from the open end of the overflow tube. In the preferred embodiment the screen 78 is placed in the comer of the trough 50 containing the overflow tube 76, so that the screen 78 passes upwardly from the bottom 52 of the trough 50 and then over to the closest end 61 of the trough 50. The screen 78 as shown in FIG. 5 provides a large surface area, thereby preventing the screen 78 from easily become clogged with debris. It should be apparent to one skilled in the art that the screen may be formed in a variety of configurations, sizes, and shapes without departing from the broader spirit of the invention.

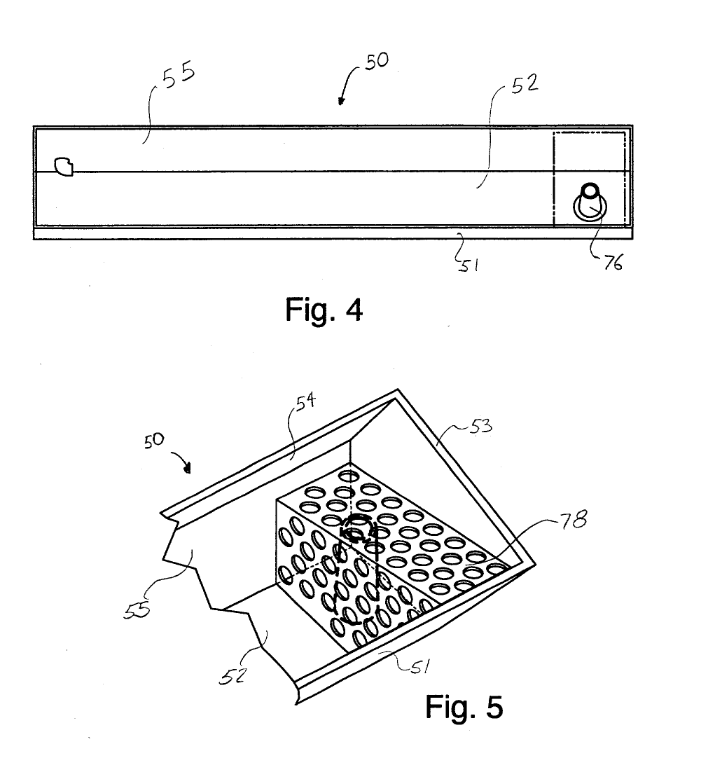

The water intake system 62 includes a water inlet (not shown), a solenoid 82, a supply manifold 84, and a plurality of water supply lines 80. The water supply lines 80 are flexible plastic tubing in the preferred embodiment, although a variety of other material may readily be used. The solenoid 82 can be almost any solenoid 82 designed to regulate or control the flow of water. The solenoid 82 is attached to the control box 66, which controls the operation of the solenoid 82. The water supply manifold 84 is connected to the solenoid 82 and distributes water to the individual water supply lines 80. The water supply manifold 84 may be placed almost anywhere in the display case, but in the preferred embodiment is in the rear of the display case 10. The water supply lines 80 direct from the water supply manifold 84 to the individual troughs 80. In the preferred embodiment, the water supply lines 80 enter each trough 50 on the opposite end of the drain 74. In a more preferred embodiment, the water supply lines 80 enter the trough 50 near the bottom 52 and include an elbow 86 to direct water flow to the drain, as shown in FIG. 4.

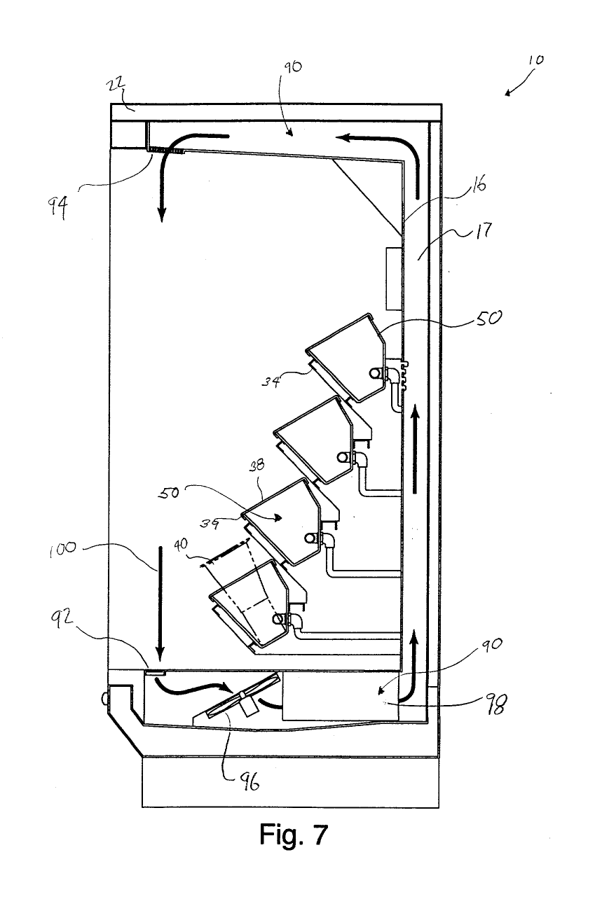

The cooling system 90 provides cooled air to create a temperature-controlled environment, thereby maintaining the freshness of the flowers. The cooling system 90 includes an air return 92, an air discharge 94, a fan 96 and a cooling means 98. The cooling means 98 is well known in the art and used in many refrigerated display cases. The cooling system 90 generally operates to form an air curtain 100 between the inside and outside of the display case 10. The air return 92 and air discharge 94 may include covers or grates 95 that are formed to define a plurality of holes or slots (not shown) to allow air passage. The exact style and configuration of the grates 95 may vary as aesthetically desired or be formed to direct the air as desired. These covers or grates 95 are well known in the art and used for many cooled display cases. The air return 92 and air discharge 94 are located on the display case 10 to provide the air curtain 100. In the preferred embodiment, the fan 96 is a coil fan, well known in the art, although a variety of other types of fans may be easily substituted. The fan 96 forces air through the cooling means 98, and can be located in a variety of places within the display case 10. If a plurality of fans 96 are used, the fans 96 extend along the length of the display case 10. In an even more preferred embodiment, the air is discharged only through the air discharge 94. This allows the air to be directed to the air return 92 without directly blowing on the flowers, thereby maintaining their freshness. The cooling means may also include a duct 17 within the rear wall 16 of the display case 10 to allow air to pass from the air return 92 to the air discharge 94. The duct 17 also continues through the top member 22 to the air discharge 94. The cooling means 90 may be located in the bottom of the display case 10 (as shown in FIG. 7), on the top of the display case 10, along the rear wall 16 of the display case 10 or in any other position that provides the necessary cooling. The cooling means 90 may also be located in multiple locations such as both the top and the bottom of the display case 10.

II. Assembly

The display case 10 is assembled as is well known in the art for most refrigerated or cooled display cases. The troughs 50 are manufactured from ABS plastic and formed to shape. The ends are then welded into place. The watering system 60 is added to the display case 10 during assembly. More specifically, the drain system 64 is first installed in the internal rear back area as well as externally under the case by attaching the drain trap 74. Next the electrical wiring (not shown) including the control box 66 is installed. Then the water intake system 64 is installed. After this, the floral display system 30 is installed and the individual drain pipes 70 and water supply lines 80 are installed. Therefore, in the preferred embodiment, the display case is preassembled when it arrives at the customer. The customer only needs to provide an electrical connection, a water supply, and an external drain. Once the water, electric and external drain are connected, the display case 10 is ready for operation.

III. Operation

Operation of the display case is operated through the control box 66. Once the display case 10 is connected to a power source, the power switch (not shown) in the control box 66 may be turned on. The control box 66 generally includes a thermostat, preferably set by the manufacture for the size of the display case that controls the temperature of the display case and activates the cooling system 90. In the preferred embodiment, the control box 66 also includes a timer switch, and a timer (not shown). With the main power switch turned on to allow the water to flow, the timer switch may be activated to override the timer and allow a new fill cycle to start. The timer sets how many times a day the troughs 50 will be flushed with new water, and how long each flush cycle lasts.

When the control box 66 is turned on, the display case is readied to receive merchandise by the cooling system 90 cooling the display case 10 to the proper temperature and the watering system flushing clean the troughs 50 and filling them with water. Upon the water switch and the timer switch being activated, the display case starts a fill cycle. The control box 66 allows the solenoid 82 to open so that water passes through the water supply manifold 84 and out to each trough 50 through the water supply lines 80. The water fills the troughs 50 until it reaches a level above the top of the overflow tube 76. The water maintains this level within each trough 50 by the excess flowing over the top lip 77 of the overflow tube 76. This excess water passes down through the overflow tube 76, into the drain 56, through the drain tubes 70, into the drain manifold 72 and through the drain trap 74. The drain trap 74 holds a small portion of the water as is well known in the art to prevent any smells from the drainage pipes outside of the display case from entering the display case and degrading the quality of the air within the display case 10. The fill cycle continues until shut off by the timer. The fill cycle may continue beyond the point when the troughs 50 are full of water to allow the water to flush the troughs 50 free of debris. During set up, the floral cups 40 may be inserted into the openings 39 on the covers 38 before or after the troughs 50 are filled with water.

The fill cycle of the troughs 50 in the display case 10 may be set by the control box 66 to clean the troughs 50, or refresh the water in the troughs at various intervals. The length of the cycle and number of cycles per day is set by the timer. When the timer starts a refresh or new fill cycle, fresh water may already be in the troughs 50. When the water enters the troughs 50, in the preferred embodiment, the elbow 86 on the water supply lines 80 directs the water to the other end of the trough 50, in the direction of the overflow tube 76. This directed flow washes debris in the trough 50 toward the overflow tube 76. In the preferred embodiment, the smaller particles of debris, that will not clog the drain, pass through the holes 79 within the screen 78 and through the overflow tube 76 to be flushed out of the display case 10 through the drain system 64. The larger particles of debris become trapped on the screen 78 until cleaned off, or until they are broken into smaller pieces that may pass out of the drain system 64. Due to the somewhat closed design of the floral cups 40 and the covers 38 over the troughs 50, larger pieces of debris should rarely enter the water in the troughs. Therefore, the water in the troughs should stay clear of debris because the smaller particles are washed out during each refresh/fill cycle. The refresh and fill cycles provide fresh water full of nutrients to help the flowers maintain their freshness. These cycles allow the display case 10 to operate with very little maintenance from the user.

If the troughs 50 need cleaning beyond a fill/refresh cycle, the covers 38 may easily be removed, even if they still contain the floral cups 40, to allow easy access to the interior of the troughs 50. The removal of the troughs 50 allows the user to visibly inspect or clean the troughs 50 in a safe and thorough manner. The user may remove the screen 78 and then remove the overflow tube 76 from the drain 56 to allow all water to exit the troughs 50. This allows easy cleaning of the interior surface of the troughs 50. After cleaning the user may replace the overflow tube 76 into the drain 56 and place the screen 76 back into position. The covers 38 may then be replaced over the troughs 50, and if necessary, the floral cups 40 replaced into the openings 39 defined by the covers 38. The user then manually starts a fill cycle using the timer switch (not shown) on the control box 66. Of course, other methods of filling may be used, such as a user manually opening a valve and closing when filled, or a switch that the user turns on until full.

The cooling system 90 keeps the interior of the display case 10 at or below a specified temperature. In the preferred embodiment, the cooling system 90 uses an air curtain 100 to efficiently keep the contents of the display case cold. The cooling system 90 pulls air from the somewhat upwardly facing air return 92 located near the front of the display case 10, in the base 14. A fan 96, or a plurality of fans, pulls air from the air return 92 and pushes or pulls it through the cooling means 98. More specifically, the cooling system 90 draws air into the display case 10, routes it through the base 14, through the cooling means 98, through ducts 17 in the rear wall 16 and top member 22 to exit the air discharge 94. The cooling means 98 chills the air before it is forced out of the air discharge 94 located in the top member 22 of the display case 10, near the front side. The air is directed to flow somewhat downwardly to the air return 92, thereby creating the air curtain 100. The air curtain 100 maintains a controlled temperature environment for the flowers behind the air curtain 100. The space under the troughs 50 is open to allow the air to circulate and cool all troughs 50.

IV. Alternative Embodiments

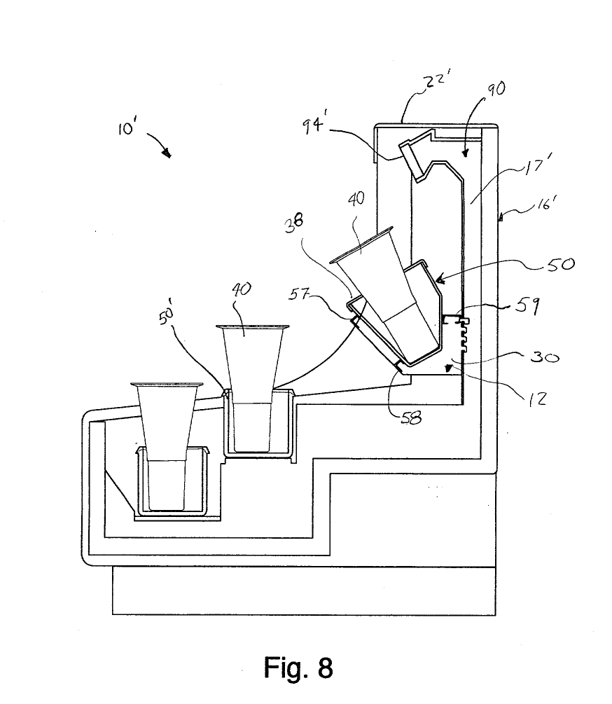

A first alternative display case 10′ may be seen in FIG. 8. This first alternative display case 10′ is designed for situations where the height of the preferred embodiment is not possible, or unaesthetically pleasing. This display case 10′ is formed as in the preferred embodiment, except that there may be a fewer number of troughs 50, the outer support structure 12′ is altered to be shorter, yet allow easy access, and the cooling system 90 may be altered to provide an air curtain 100 in the altered display case 10′. More specifically, the rear wall 16′ is shortened in height, and the top member 22′ is reduced to allow a consumer to easily see the cut flowers within the display case 10′. The left and right side walls 18′ and 20′ may also be modified to match the lowered shape of the display case 10′, or to be more aesthetically pleasing. The top member 22′ is much shorter and allows the consumer to view the flowers from over the top of the display case 10′. The cooling system must also have a reduced duct 17′ with the air discharge 94′ being located by the rear wall 16′. The air discharge 94′ is angled to allow cool air to pass over the tops of the flowers, yet direct the air to the air return 92′ to form an air curtain 100′. The watering system 60 is placed in the display case in a similar manner to the preferred embodiment, and operates the same way. The troughs 50 may have different shapes to fit within the modified display case 10′ and even face upward on some of the troughs 50′ because the consumer may be viewing or picking the flowers from above, not reaching forward.

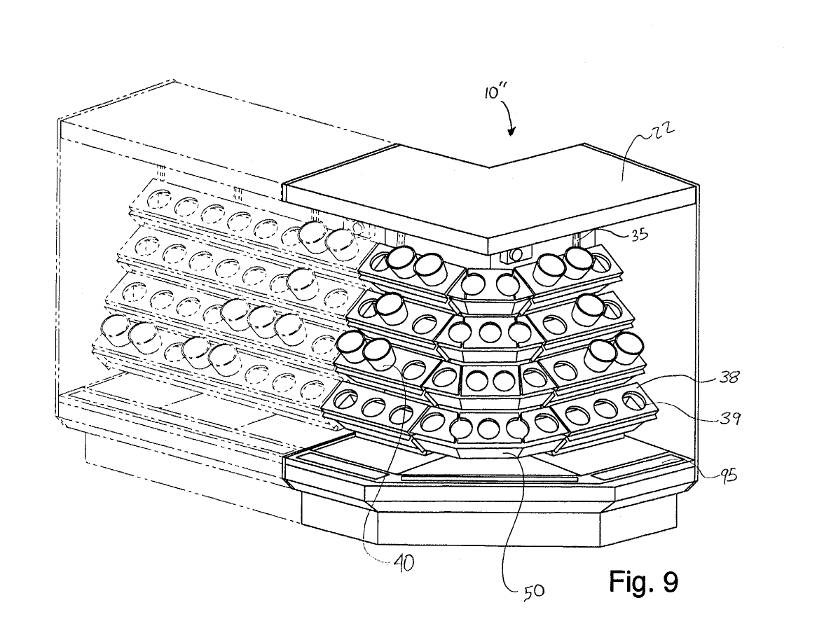

A second alternative display case may be seen in FIG. 9. This display case 10″ is sized and shaped to fit on or around a corner in a store. The display case 10″, as shown in FIG. 9 may also attach to a display case 10″ as in the preferred embodiment to provide a wide selection of flowers. The troughs 50 may be bent around the corner in a continual shape, or they may include multiple troughs to allow easier turning of the corner. The watering system 60 and cooling system 90 remain similar to that described in the preferred embodiment.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents.

The embodiments of the invention in which and exclusive property or privilege is claimed are defined as follows:

1- display case for cut flowers comprising:
an outer case comprising a base, a rear wall, and a top member, said outer case defining an open front;
a plurality of troughs having an opening, said opening facing said top member and said open front, said troughs being spaced-apart in an upwardly terraced relationship
a plurality of covers, said covers sized to fit over said opening, said covers enclosing said troughs, said covers defining a plurality of holes; and
a water inlet and a drain on at least one of said troughs, said water inlet and said drain arranged to permit said troughs to fill with liquid.

2- The display case of claim 1 wherein said water inlet includes an elbow, said elbow defining an opening facing said drain.

3- The display case of claim 1 further comprising a plurality of floral cups, said floral cups fitting within said holes, said floral cups having upwardly facing openings for receiving and support cut flowers.

4- The display case of claim 1 wherein said drain includes an overflow tube.

5- The display case of claim 1 wherein said troughs include a screen.

6- The display case of claim 1 further comprising a cooling means including an air return within said base and an air discharge within said top member, said cooling means directing air between said air return and said air discharge, said directed air forming an air curtain.

7- The display case of claim 6 wherein said air curtain creates a thermal barrier between said troughs within said display case and the air outside of said display case

8- A display case for cut flowers comprising:
a base member, a rear wall, and a top member defining an open front;
a plurality of elongated troughs in a terraced relationship with one another, said troughs fitting within said open front, said troughs having an elongated opening;
a removable cover sized to cover said elongated opening, said cover defining at least two holes;
a plurality of floral cups sized to fit within said holes, said floral cups having upwardly facing openings;
a water supply means for supplying water to each of said troughs; and
an overflow tube interconnected to said troughs for maintaining a predetermined water level in each of said troughs.

9- The display case of claim 8 further comprising a cooling means, said cooling means forming an air curtain.

10- The display case of claim 9 wherein said air curtain is formed by said cooling means directing air between an air return within said base and an air discharge within said top member.

11- The display case of claim 8 wherein said water supply means further comprises a water intake, a water manifold and a solenoid, said water intake capable of supplying water to said water manifold, said solenoid controlling the flow of water between said water intake and said water manifold.

12- The display case of claim 12 wherein said water supply means further comprises water supply lines, said water supply lines connecting said water manifold and said troughs.

13- The display case of claim 8 wherein said troughs include a water inlet, said water inlet including an elbow, said elbow including an opening, said opening directed toward said drain.

14- The display case of claim 8 further comprising a drain system, said drain system comprising a drain outlet, a drain manifold.

15- The display case of claim 14 wherein said drain system further comprises a drain connected to said trough, said overflow tube interconnecting with said drain.

16- The display case of claim 14 wherein said drain system further comprises a drain trap, said drain trap being interconnected between said drain outlet and said drain manifold.

17- A watering system for a display case comprising:
a plurality of elongated troughs, each of said troughs including a drain and an overflow tube connected to said drain, said troughs defining an elongated opening, said troughs including a cover for enclosing said opening;
a water supply means for supplying water to said troughs, said water supply means comprising a valve controlling the supply of water to the troughs; and
a drain system comprising a drain trap and a plurality of pipes interconnecting said drains and said drain trap.

18- The watering system of claim 17 wherein said troughs include screen, said screen separating the drain from the majority of said trough.

19- The watering system of claim 17 further comprising a control panel, said control panel including a timer, said timer controlling said valve.

20- The watering system of claim 17 wherein said water supply means includes a plurality of water pipes, said water pipes interconnecting with said troughs, said water pipes defining an opening facing said drain.
